(19) United States
(12) Patent Application Publication
(10) Pub. No.: US 2026/0150161 A1
(43) Pub. Date: May 28, 2026

(54) ELECTROMAGNETIC WAVE HEATING APPARATUS

(71) Applicant: Mitsubishi Electric Corporation, Tokyo (JP)

(72) Inventors: Jun NISHIJIMA, Tokyo (JP); Takashi UNO, Tokyo (JP); Tetsu OWADA, Tokyo (JP)

(73) Assignee: Mitsubishi Electric Corporation, Tokyo (JP)

(21) Appl. No.: 19/448,813

(22) Filed: Jan. 14, 2026

Related U.S. Application Data
(63) Continuation of application No. PCT/JP2023/026915, filed on Jul. 24, 2023.

(51) Int. Cl. H05B 6/64; F28D 15/00; H05B 6/72

(52) U.S. Cl. CPC H05B 6/6402; F28D 15/00; H05B 6/72

(57) ABSTRACT

An electromagnetic wave heating apparatus includes: an electrically conductive housing; an electromagnetic wave generating unit that generates electromagnetic waves which are linearly polarized waves; a plurality of radiating units that radiate, to an inside of the housing, the electromagnetic waves generated by the electromagnetic wave generating unit; a directivity control unit that controls directivity of the electromagnetic waves from the plurality of radiating units; and an electromagnetic wave absorbing unit that is disposed inside the housing in such a manner that the electromagnetic wave absorbing unit aligns with a vibration plane of the electromagnetic waves, and absorbs electromagnetic waves inside the housing.

### CROSS REFERENCE TO RELATED APPLICATION

This application is a Continuation of PCT International Application No. PCT/JP 2023/026915, filed on Jul. 24, 2023, which is hereby expressly incorporated by reference into the present application.

### TECHNICAL FIELD

The present disclosure relates to an electromagnetic wave heating apparatus.

### BACKGROUND ART

Conventionally, a microwave heating apparatus that controls the radiation direction of microwaves from a plurality of antennas installed on the same plane in order to create a temperature difference between a heating target object which is a target object to be heated and a non-heating target object which is not a target object to be heated has been disclosed (see Non-Patent Literature 1).

### CITATION LIST

### Non-Patent Literature

Non-Patent Literature 1: Yang Yang, Zhipeng Fan, Tao Hong, Maoshun Chen, Xiangwei Tang, Jianbo He, Xing Chen, Changjun Liu, Huacheng Zhu, and Kama Huang, Design of Microwave Directional Heating System Based on Phased-Array Antenna, IEEE TRANSACTIONS ON MICROWAVE THEORY AND TECHNIQUES, VOL. 68, NO.11, NOVEMBER 2020, p. 4896-4904.

### SUMMARY OF INVENTION

### Technical Problem

However, there is a problem with the electromagnetic wave heating apparatus described in Non-Patent Literature 1 that, due to repeated reflections of electromagnetic waves on inner surfaces of a metallic housing, the reflected electromagnetic waves heat not only the heating target object but also the non-heating target object, thereby making it difficult to create a sufficient temperature difference between the heating target object and the non-heating target object.

The present disclosure aims to solve the problem, and an object thereof is to provide an electromagnetic wave heating apparatus that can create a greater temperature difference between a heating target object and a non-heating target object compared to conventional techniques.

### Solution to Problem

An electromagnetic wave heating apparatus according to the present disclosure includes: an electrically conductive housing; an electromagnetic wave generator to generate electromagnetic waves which are linearly polarized waves; a plurality of radiators to radiate, to an inside of the housing, the electromagnetic waves generated by the electromagnetic wave generator; a directivity controller to control directivity of the electromagnetic waves from the plurality of radiators; and an electromagnetic wave absorber that is disposed inside the housing in such a manner that the electromagnetic wave absorber aligns with a vibration plane of the electromagnetic waves, and to absorb electromagnetic waves inside the housing.

### Advantageous Effects of Invention

According to the present disclosure, the electromagnetic wave absorbing unit that absorbs electromagnetic waves is included in such a way as to align with the vibration plane of electromagnetic waves whose directivity is controlled. Accordingly, it is possible to reduce the reflections of the electromagnetic waves on inner surfaces of the housing, and create a greater temperature difference between a heating target object and a non-heating target object compared to conventional techniques.

### BRIEF DESCRIPTION OF DRAWINGS

FIG. 1 is a cross-sectional view schematically illustrating the configuration of an electromagnetic wave heating apparatus according to a first embodiment.

FIG. 2 is a drawing illustrating simulation results of the electrical field distribution inside the housing of the electromagnetic wave heating apparatus according to the first embodiment.

FIG. 3 is a cross-sectional view schematically illustrating the configuration of an electromagnetic wave heating apparatus according to a second embodiment.

FIG. 4 is a cross-sectional view schematically illustrating the configuration of an electromagnetic wave heating apparatus according to a third embodiment.

FIG. 5 is a cross-sectional view schematically illustrating the configuration of an electromagnetic wave heating apparatus according to a fourth embodiment.

FIG. 6 is a cross-sectional view schematically illustrating the configuration of an electromagnetic wave heating apparatus according to a fifth embodiment.

FIG. 7 is a cross-sectional view schematically illustrating the configuration of an electromagnetic wave heating apparatus according to a sixth embodiment.

FIG. 8 is a cross-sectional view schematically illustrating electromagnetic wave absorbing units of the electromagnetic wave heating apparatus according to the sixth embodiment.

### DESCRIPTION OF EMBODIMENTS

Hereinbelow, embodiments according to the present disclosure are explained in detail with reference to the drawings.

### First Embodiment

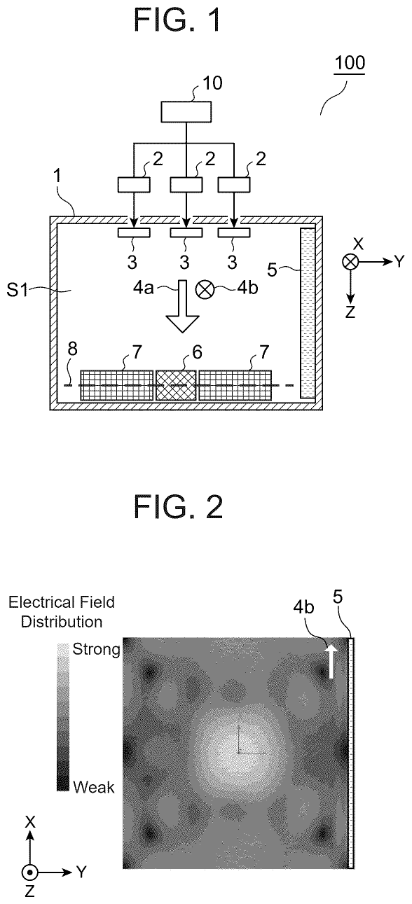

First, the schematic configuration of an electromagnetic wave heating apparatus 100 according to a first embodiment is explained with reference to FIG. 1. FIG. 1 is a cross-sectional view schematically illustrating the configuration of the electromagnetic wave heating apparatus 100 according to the first embodiment. The electromagnetic wave heating apparatus 100 according to the first embodiment is a microwave oven for cooking, a microwave heating apparatus, or another electromagnetic wave heating apparatus, and is an apparatus for heating a heating target object 6 which is a target object to be heated by irradiating the heating target object 6 with electromagnetic waves. As illustrated in FIG. 1, the electromagnetic wave heating apparatus 100 includes: an electrically conductive housing 1; an electromagnetic wave generating unit 10 that generates electromagnetic waves; a plurality of phase control units 2 that control the phase of electromagnetic waves generated by the electromagnetic wave generating unit 10; a plurality of antennas 3 that radiate, to a space S1 inside the housing 1, the electromagnetic waves whose phase is controlled by the phase control unit 2; and an electromagnetic wave absorbing unit 5 that absorbs part of the electromagnetic waves radiated to the space S1.

The housing 1 is formed in a box shape using an electrically conductive material, and forms the space S1 serving as a heating chamber therein. By being formed using the electrically conductive material, the housing 1 reduces the leakage of internally radiated electromagnetic waves to the outside. For example, the housing 1 is formed in a rectangular parallelepiped shape using carbon steel, special steel, or other alloys. The electromagnetic wave generating unit 10 generates electromagnetic waves which are linearly polarized waves, and distributes the generated electromagnetic waves to the plurality of phase control units 2. For example, the electromagnetic wave generating unit 10 is configured using a magnetron, and generates microwaves which are linearly polarized waves.

The phase control units 2 control the directivity of the electromagnetic waves by the superimposition of electromagnetic waves to be radiated from the plurality of antennas 3 to the space S1 by controlling the phase of electromagnetic waves generated by the electromagnetic wave generating unit 10. In other words, the plurality of phase control units 2 control the directivity of the electromagnetic waves from the plurality of antennas 3 serving as a multi-element antenna. For example, the phase control units 2 are configured using electronic circuits or the like that function as phase shifters.

For example, the plurality of phase control units 2 control the directivity of the electromagnetic waves from the plurality of antennas 3 in such a manner that the direction of the electromagnetic waves from the plurality of antennas 3 aligns with a direction 4a (propagation direction, Z direction) illustrated in FIG. 1. Note that it is assumed in the first embodiment that the polarization plane of the electromagnetic waves (the vibration plane of polarized waves) from the plurality of antennas 3 aligns with the direction 4a and a direction 4b (polarization direction, X direction) illustrated in FIG. 1. In addition, in the first embodiment, the plurality of phase control units 2 are included in a directivity control unit that controls the directivity of the electromagnetic waves from the plurality of antennas 3.

For example, the plurality of antennas 3 are arranged on the upper surface of the inside of the housing 1 formed in a rectangular parallelepiped shape in such a manner that the plurality of antennas 3 are aligned along the upper surface of the inside, and radiate the electromagnetic waves in the downward direction 4a. Note that, in the first embodiment, the plurality of antennas 3 are included in a plurality of radiating units that radiate electromagnetic waves generated by the electromagnetic wave generating unit 10 to the inside of the housing 1.

The electromagnetic wave absorbing unit 5 is disposed inside the housing 1 in such a manner that the electromagnetic wave absorbing unit 5 aligns with the vibration plane of the electromagnetic waves from the plurality of antennas 3, and absorbs electromagnetic waves by converting part of incident electromagnetic waves into thermal energy. For example, the electromagnetic wave absorbing unit 5 is configured using a synthetic resin in which powders of a magnetic material are incorporated. In addition, for example, the electromagnetic wave absorbing unit 5 is formed in a plate-like shape or a sheet-like shape, and is disposed to be in contact with or close to an inner surface of the housing 1. In addition, for example, the electromagnetic wave absorbing unit 5 is disposed to cover approximately the whole of one surface of the inside of the housing 1 formed in a rectangular parallelepiped shape. Note that it is desirable that the electromagnetic wave absorbing unit 5 be disposed to be in close contact with an inner surface of the housing 1. In addition, the electromagnetic wave absorbing unit 5 is not limited to being disposed to be in direct contact with an inner surface of the housing 1, but, for example, may be disposed to be in indirect contact, with a heat conductive sheet, a heat conductive grease, an adhesive, or the like being interposed therebetween.

In addition, the electromagnetic wave absorbing unit 5 is disposed in such a manner that at least part of the surface of the electromagnetic wave absorbing unit 5 on the central side of the space S1 aligns with the polarization plane. In other words, the electromagnetic wave absorbing unit 5 is disposed in such a manner that at least part of the surface of the electromagnetic wave absorbing unit 5 on the central side of the space S1 is approximately parallel to the direction 4a and the direction 4b. Note that it is desirable that the electromagnetic wave absorbing unit 5 be formed in a tabular shape, and be disposed in such a manner that approximately the whole surface of the electromagnetic wave absorbing unit 5 on the central side of the space S1 extends in a direction aligning with the polarization plane. By being disposed in this manner, the electromagnetic wave absorbing unit 5 reduces the absorption of electromagnetic waves propagating in the direction 4a, and makes it easier to absorb electromagnetic waves propagating in a direction crossing the direction 4a in the space S1.

Typically, in an electromagnetic wave heating apparatus such as a microwave oven, electromagnetic waves are radiated to the inside of the electromagnetic wave heating apparatus from an antenna, and the radiated electromagnetic waves are reflected repeatedly on inner surfaces of a metallic housing, thereby behaving as stationary waves inside the electromagnetic wave heating apparatus. Because of this, even if it is attempted to selectively heat a plurality of areas inside the electromagnetic wave heating apparatus by controlling the directivity of electromagnetic waves, it is difficult to create a sufficient temperature difference between a heating target object present in a heating area aimed for heating and a non-heating target object present in a non-heating area aimed not for heating, due to the influence of stationary waves resulting from reflected waves from inner surfaces of the housing.

In contrast to this, by making it easier to absorb, with the electromagnetic wave absorbing unit 5, reflected waves that are generated when the electromagnetic waves radiated from the plurality of antennas 3 are reflected by inner surfaces of the housing 1, the electromagnetic wave heating apparatus 100 according to the first embodiment can reduce the generation of stationary waves in the space S1, and create a greater temperature difference between a heating target object and a non-heating target object compared to conventional techniques. In other words, by making it easier to absorb, with the electromagnetic wave absorbing unit 5, electromagnetic waves in a direction crossing the vibration plane of the electromagnetic waves from the plurality of antennas 3, the electromagnetic wave heating apparatus 100 according to the first embodiment can reduce the generation of stationary waves in the space S1, and create a greater temperature difference between a heating target object and a non-heating target object compared to conventional techniques.

FIG. 2 is a drawing illustrating simulation results of the electrical field distribution inside the housing of the electromagnetic wave heating apparatus 100 according to the first embodiment. Specifically, FIG. 2 is a drawing illustrating simulation results of the electrical field distribution of an electromagnetic field control plane 8 illustrated in FIG. 1 of the inside of the housing of the electromagnetic wave heating apparatus 100 according to the first embodiment when seen in the direction 4a illustrated in FIG. 1. As illustrated in FIG. 2, the electromagnetic wave heating apparatus 100 increases the electrical field strength of the middle heating area by controlling the directivity of electromagnetic waves from the plurality of antennas 3 in such a manner that the electromagnetic waves from the plurality of antennas 3 are directed toward the middle of the electromagnetic field control plane 8, and reduces the electrical field strength of portions other than the middle by preventing electromagnetic waves from the plurality of antennas 3 that from behaving as stationary waves in the space S1 after being reflected on inner surfaces of the housing 1.

As explained above, the electromagnetic wave heating apparatus 100 according to the first embodiment includes: the electrically conductive housing 1; the electromagnetic wave generating unit 10 that generates electromagnetic waves which are linearly polarized waves; the plurality of antennas 3 that radiate, to the inside of the housing 1, the electromagnetic waves generated by the electromagnetic wave generating unit 10; the phase control units 2 that control the directivity of the electromagnetic waves from the plurality of antennas 3; and the electromagnetic wave absorbing unit 5 that is disposed inside the housing 1 in such a manner that the electromagnetic wave absorbing unit 5 aligns with the vibration plane of the electromagnetic waves, and absorbs electromagnetic waves inside the housing 1. By being configured in this manner, since the electromagnetic wave heating apparatus 100 according to the first embodiment includes the electromagnetic wave absorbing unit 5 that is disposed in such a manner that the electromagnetic wave absorbing unit 5 aligns with the vibration plane of the electromagnetic waves whose directivity is controlled, and absorbs electromagnetic waves, the electromagnetic wave heating apparatus 100 reduces the reflections of electromagnetic waves on an inner surface of the housing 1, and creates variations in the strength of the electrical field distribution in the space S1, thereby making it possible to create a greater temperature difference between the heating target object 6 and a non-heating target object 7 compared to conventional techniques.

In addition, the electromagnetic wave heating apparatus 100 according to the first embodiment includes the electromagnetic wave absorbing unit 5 disposed to be in contact with or close to an inner surface of the housing 1. Thereby, the electromagnetic wave heating apparatus 100 according to the first embodiment reduces the reflections of electromagnetic waves between the electromagnetic wave absorbing unit 5 and the inner surface of the housing 1, reduces a temperature rise of the electromagnetic wave absorbing unit 5 by making it easier for heat generated in the electromagnetic wave absorbing unit 5 to be transferred to the housing 1, and reduces the heating of the non-heating target object 7 due to the radiation from the electromagnetic wave absorbing unit 5.

Note that, whereas the electromagnetic wave heating apparatus 100 according to the first embodiment is configured in such a manner that electromagnetic waves generated by the electromagnetic wave generating unit 10 are distributed to the plurality of phase control units 2, and the plurality of phase control units 2 control the phase of a plurality of the electromagnetic waves, this is not the sole example. It is sufficient if the electromagnetic wave heating apparatus is configured in such a manner that the directivity of electromagnetic waves radiated from the plurality of antennas is controlled. For example, the electromagnetic wave heating apparatus may be provided with an electromagnetic wave generating unit for each of the plurality of antennas, and may be configured in such a manner that the generation timing of electromagnetic waves is controlled for each of the electromagnetic wave generating units.

### Second Embodiment

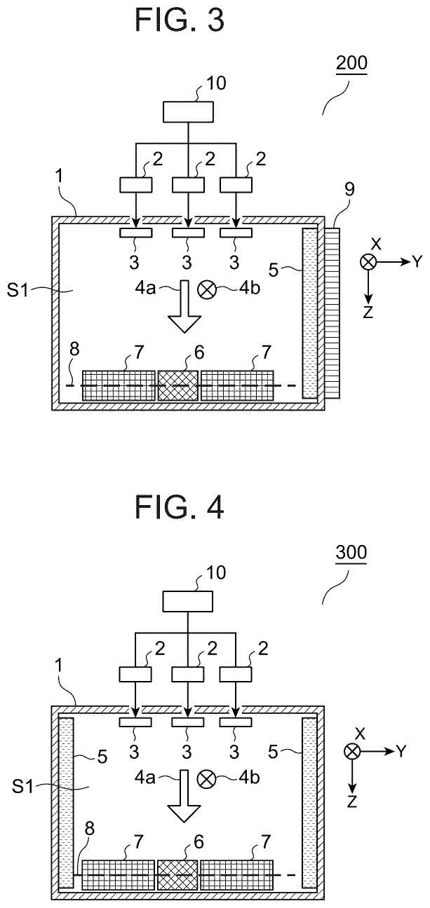

Next, an electromagnetic wave heating apparatus 200 according to a second embodiment is explained with reference to FIG. 3. The electromagnetic wave heating apparatus 200 according to the second embodiment is different from the electromagnetic wave heating apparatus 100 according to the first embodiment in that the electromagnetic wave heating apparatus 200 includes a heat dissipating unit 9. Other constituent elements are the same, the constituent elements which are the same as those in the first embodiment are given identical reference signs, and explanation thereof is omitted.

FIG. 3 is a cross-sectional view schematically illustrating the configuration of the electromagnetic wave heating apparatus 200 according to the second embodiment. As illustrated in FIG. 3, the electromagnetic wave heating apparatus 200 includes: a housing 1; an electromagnetic wave generating unit 10; a plurality of phase control units 2; a plurality of antennas 3; an electromagnetic wave absorbing unit 5 that absorbs part of electromagnetic waves radiated to a space S1; and the heat dissipating unit 9 for dissipating heat generated in the electromagnetic wave absorbing unit 5 to the outside of the housing 1.

For example, the heat dissipating unit 9 serving as a dissipating unit is disposed to be exposed to the outside of the housing 1 in such a manner that the heat dissipating unit 9 and the electromagnetic wave absorbing unit 5 sandwich a certain surface of the housing 1, and dissipates, to the outside of the housing 1, heat generated in the electromagnetic wave absorbing unit 5 by transferring the heat via the housing 1. For example, the heat dissipating unit 9 is disposed to overlap the electromagnetic wave absorbing unit 5 when seen in a direction (e.g. the Y direction illustrated in FIG. 3) orthogonal to a surface of the housing 1 where the electromagnetic wave absorbing unit 5 is disposed, and is formed to have a size which is approximately the same as the electromagnetic wave absorbing unit 5 when seen in the direction.

In addition, for example, the heat dissipating unit 9 is disposed to be in contact with or close to the outer surface of the housing 1. Note that it is desirable that the heat dissipating unit 9 be disposed to be in close contact with the outer surface of the housing 1. In addition, the heat dissipating unit 9 is not limited to being disposed to be in direct contact with the outer surface of the housing 1, but, for example, may be disposed to be in indirect contact, with a heat conductive sheet, a heat conductive grease, an adhesive, or the like being interposed therebetween. In addition, the electromagnetic wave heating apparatus 200 may include a fan that is disposed outside the housing 1, and is for dissipating the heat of the heat dissipating unit 9 to external air.

By being disposed in this manner, the electromagnetic wave absorbing unit 5 and the heat dissipating unit 9 make it possible for the electromagnetic wave heating apparatus 200 to reduce a temperature rise of the electromagnetic wave absorbing unit 5 by making it easier for heat generated in the electromagnetic wave absorbing unit 5 to be transferred to the heat dissipating unit 9, to reduce the heating of a non-heating target object 7 due to the radiation from the electromagnetic wave absorbing unit 5, and to cope with heating for a longer time than the electromagnetic wave heating apparatus 100 according to the first embodiment can.

### Third Embodiment

Next, an electromagnetic wave heating apparatus 300 according to a third embodiment is explained with reference to FIG. 4. The electromagnetic wave heating apparatus 300 according to the third embodiment is different from the electromagnetic wave heating apparatus 100 according to the first embodiment in the configuration related to electromagnetic wave absorbing units. Other constituent elements are the same, the constituent elements which are the same as those in the first embodiment are given identical reference signs, and explanation thereof is omitted.

FIG. 4 is a cross-sectional view schematically illustrating the configuration of the electromagnetic wave heating apparatus 300 according to the third embodiment. As illustrated in FIG. 4, the electromagnetic wave heating apparatus 300 includes: a housing 1; an electromagnetic wave generating unit 10; a plurality of phase control units 2; a plurality of antennas 3; and a plurality of electromagnetic wave absorbing units 5 that absorb part of electromagnetic waves radiated to a space S1.

For example, the electromagnetic wave heating apparatus 300 includes a pair of electromagnetic wave absorbing units 5. A first electromagnetic wave absorbing unit 5 is disposed in such a manner that at least part of the surface of the first electromagnetic wave absorbing unit 5 on the central side of the space S1 aligns with a polarization plane, and a second electromagnetic wave absorbing unit 5 is disposed in such a manner that at least part of the surface of the second electromagnetic wave absorbing unit 5 on the central side of the space S1 aligns with the polarization plane, and faces the first electromagnetic wave absorbing unit 5 with a distance therebetween. In addition, for example, the electromagnetic wave heating apparatus 300 includes a pair of electromagnetic wave absorbing units 5 that are formed in a tabular shape, and are arranged to face each other in such a manner that the pair of electromagnetic wave absorbing units 5 aligns with a polarization plane. A first electromagnetic wave absorbing unit 5 is disposed to be in contact with or close to a certain inner surface of the housing 1 formed in a box shape, and a second electromagnetic wave absorbing unit 5 is disposed to be in contact with or close to an inner surface of the housing 1 disposed facing the certain inner surface.

In other words, the electromagnetic wave heating apparatus 300 includes a pair of electromagnetic wave absorbing units 5 that are formed in a tabular shapes, and are arranged to be in contact with or close to inner surfaces of the housing 1 in such a manner that the pair of electromagnetic wave absorbing units 5 is parallel to each other to align with a polarization plane. Note that, similarly to the electromagnetic wave heating apparatus 100 according to the first embodiment, in the electromagnetic wave heating apparatus 300 according to the third embodiment, it is also desirable that the plurality of electromagnetic wave absorbing units 5 are arranged to be in close contact with inner surfaces of the housing 1. In addition, in the third embodiment, the first electromagnetic wave absorbing unit 5 is included in the first electromagnetic wave absorbing unit, and the second electromagnetic wave absorbing unit 5 is included in the second electromagnetic wave absorbing unit.

In this manner, the electromagnetic wave heating apparatus 300 according to the third embodiment includes the pair of electromagnetic wave absorbing units 5 arranged to face each other in contact with or close to inner surfaces of the housing 1. Thereby, the electromagnetic wave heating apparatus 300 according to the third embodiment further reduces the reflections of electromagnetic waves on the inner surfaces of the housing 1 compared to the electromagnetic wave heating apparatus 100 according to the first embodiment, reduces a temperature rise of the electromagnetic wave absorbing units 5 by making it easier for heat generated in the electromagnetic wave absorbing units 5 to be transferred to the housing 1, and reduces the heating of the non-heating target object 7 due to the radiation from the electromagnetic wave absorbing units 5.

Note that, similarly to the electromagnetic wave heating apparatus 200 according to the second embodiment, in the third embodiment, the electromagnetic wave heating apparatus may include one or more heat dissipating units. In addition, the electromagnetic wave heating apparatus is not limited to including the pair of electromagnetic wave absorbing units 5, but may include three or more electromagnetic wave absorbing units 5. For example, in a case where the housing is formed in a rectangular parallelepiped shape, the electromagnetic wave heating apparatus may include electromagnetic wave absorbing units 5 on all the inner surfaces of the housing disposed to align with the direction 4a, or may include electromagnetic wave absorbing units 5 on all the inner surfaces including inner surfaces other than the inner surfaces disposed to align with the direction 4a. In addition, the plurality of electromagnetic wave absorbing units 5 may be formed integrally.

### Fourth Embodiment

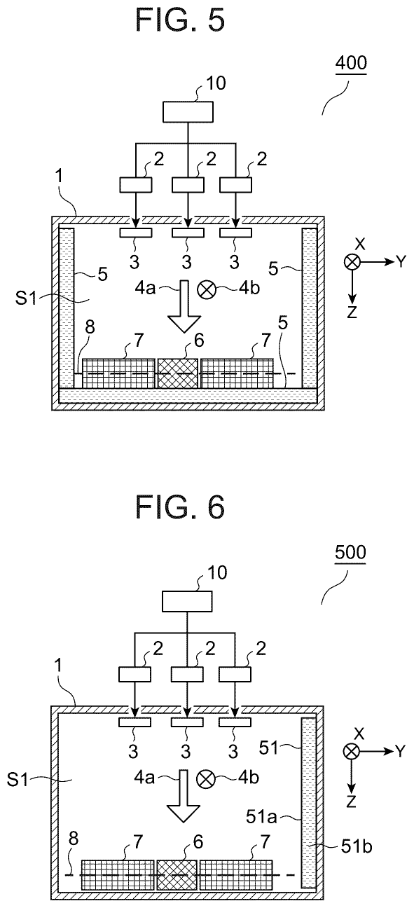

Next, an electromagnetic wave heating apparatus 400 according to a fourth embodiment is explained with reference to FIG. 5. The electromagnetic wave heating apparatus 400 according to the fourth embodiment is different from the electromagnetic wave heating apparatus 100 according to the first embodiment in the configuration related to electromagnetic wave absorbing units. Other constituent elements are the same, the constituent elements which are the same as those in the first embodiment are given identical reference signs, and explanation thereof is omitted.

FIG. 5 is a cross-sectional view schematically illustrating the configuration of the electromagnetic wave heating apparatus 400 according to the fourth embodiment. As illustrated in FIG. 5, the electromagnetic wave heating apparatus 400 includes: a housing 1; an electromagnetic wave generating unit 10; a plurality of phase control units 2; a plurality of antennas 3; and a plurality of electromagnetic wave absorbing units 5 that absorb part of electromagnetic waves radiated to a space S1.

For example, compared to the electromagnetic wave heating apparatus 300 according to the third embodiment, the electromagnetic wave heating apparatus 400 additionally includes an electromagnetic wave absorbing unit 5 disposed to be in contact or close to an inner surface of the housing 1 disposed to cross the direction 4a and align with the direction 4b. In other words, the electromagnetic wave heating apparatus 400 includes the electromagnetic wave absorbing unit 5 disposed to cross the propagation direction of electromagnetic waves. In addition, for example, the electromagnetic wave absorbing unit 5 disposed to cross the propagation direction of electromagnetic waves in this manner is disposed to cover approximately the whole of the inner surface of the housing 1 disposed to cross the propagation direction of electromagnetic waves. Note that it is also desirable that the plurality of electromagnetic wave absorbing units 5 according to the fourth embodiment be arranged to be in close contact with inner surfaces of the housing 1. In addition, the plurality of electromagnetic wave absorbing units 5 may be formed integrally.

In this manner, the electromagnetic wave heating apparatus 400 according to the fourth embodiment includes: the pair of electromagnetic wave absorbing units 5 arranged to face each other in such a manner that the pair of electromagnetic wave absorbing units 5 is in contact with or close to inner surfaces of the housing 1; and the electromagnetic wave absorbing unit 5 disposed to cross the propagation direction of electromagnetic waves. Thereby, the electromagnetic wave heating apparatus 400 according to the fourth embodiment further reduces the reflections of electromagnetic waves on the inner surfaces of the housing 1 compared to the electromagnetic wave heating apparatus 100 according to the first embodiment, reduces a temperature rise of the electromagnetic wave absorbing units 5 by making it easier for heat generated in the electromagnetic wave absorbing units 5 to be transferred to the housing 1, and reduces the heating of the non-heating target object 7 due to the radiation from the electromagnetic wave absorbing units 5.

### Fifth Embodiment

Next, an electromagnetic wave heating apparatus 500 according to a fifth embodiment is explained with reference to FIG. 6. The electromagnetic wave heating apparatus 500 according to the fifth embodiment is different from the electromagnetic wave heating apparatus 100 according to the first embodiment in the configuration related to electromagnetic wave absorbing units. Other constituent elements are the same, the constituent elements which are the same as those in the first embodiment are given identical reference signs, and explanation thereof is omitted.

FIG. 6 is a cross-sectional view schematically illustrating the configuration of the electromagnetic wave heating apparatus 500 according to the fifth embodiment. As illustrated in FIG. 6, the electromagnetic wave heating apparatus 500 includes: a housing 1; an electromagnetic wave generating unit 10; a plurality of phase control units 2; a plurality of antennas 3; and an electromagnetic wave absorbing unit 51 that absorbs part of electromagnetic waves radiated to a space S1. The electromagnetic wave absorbing unit 51 is disposed inside the housing 1 in such a manner that the electromagnetic wave absorbing unit 51 aligns with the vibration plane of electromagnetic waves from the plurality of antennas 3, and absorbs electromagnetic waves by converting part of incident electromagnetic waves into thermal energy. For example, the electromagnetic wave absorbing unit 51 is disposed to be in contact with or close to an inner surface of the housing 1. Note that it is desirable that the electromagnetic wave absorbing unit 51 be disposed to be in close contact with an inner surface of the housing 1. In addition, the electromagnetic wave absorbing unit 51 is not limited to being disposed to be in direct contact with an inner surface of the housing 1, but, for example, may be disposed to be in indirect contact, with a heat conductive sheet, a heat conductive grease, an adhesive, or the like being interposed therebetween.

The electromagnetic wave absorbing unit 51 has: a container 51a forming a closed space therein; and a liquid 51b sealed inside the container 51a. For example, the container 51a is formed using a non-metallic material that easily transmits electromagnetic waves. In addition, for example, the liquid 51b includes a liquid containing water. Note that, although it is desirable that the liquid 51b include a liquid containing water as its principal component or include water, the liquid 51b may be any liquid as long as it is a liquid that can absorb electromagnetic waves by converting part of incident electromagnetic waves into thermal energy.

When electromagnetic waves are incident on the electromagnetic wave absorbing unit 51, the liquid 51b is heated, and convection of the liquid 51b is generated in the container 51a. Thereby, it becomes easier for the electromagnetic wave absorbing unit 51 to transfer the heat of the liquid 51b to a wide range of the housing 1 by heat exchange via the liquid 51b, a temperature rise of the electromagnetic wave absorbing unit 51 is reduced, and the heating of a non-heating target object 7 by the radiation from the electromagnetic wave absorbing unit 51 is reduced.

### Sixth Embodiment

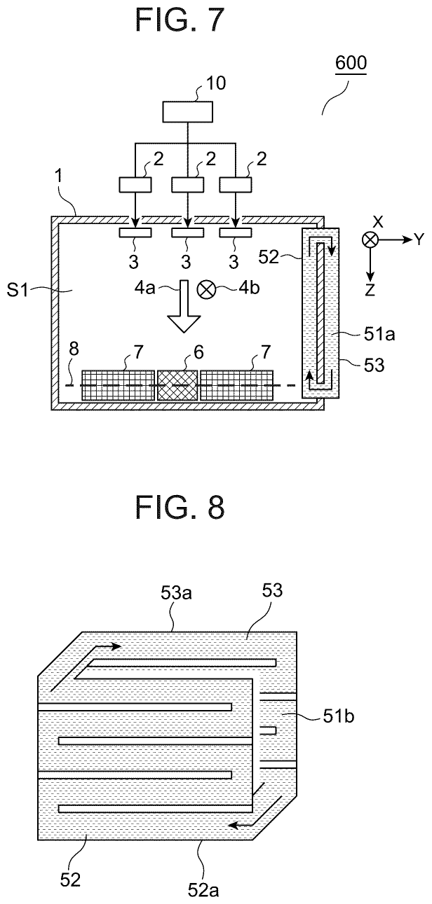

Next, an electromagnetic wave heating apparatus 600 according to a sixth embodiment is explained with reference to FIGS. 7 and 8. The electromagnetic wave heating apparatus 600 according to the sixth embodiment is different from the electromagnetic wave heating apparatus 500 according to the fifth embodiment in the configuration related to electromagnetic wave absorbing units. Other constituent elements are the same, the constituent elements which are the same as those in the fifth embodiment are given identical reference signs, and explanation thereof is omitted.

FIG. 7 is a cross-sectional view schematically illustrating the configuration of the electromagnetic wave heating apparatus 600 according to the sixth embodiment, and FIG. 8 is a cross-sectional view schematically illustrating electromagnetic wave absorbing units of the electromagnetic wave heating apparatus 600 according to the sixth embodiment. As illustrated in FIG. 7, the electromagnetic wave heating apparatus 600 includes: a housing 1; an electromagnetic wave generating unit 10; a plurality of phase control units 2; a plurality of antennas 3; and electromagnetic wave absorbing units 52 and 53 that absorb part of electromagnetic waves radiated to a space S1.

The electromagnetic wave absorbing unit 52 serving as an inner portion is disposed inside the housing 1 in such a manner that the electromagnetic wave absorbing unit 52 aligns with the vibration plane of electromagnetic waves from the plurality of antennas 3, and absorbs electromagnetic waves by converting part of incident electromagnetic waves into thermal energy. For example, the electromagnetic wave absorbing unit 52 is disposed to be in contact with or close to an inner surface of the housing 1. Note that it is desirable that the electromagnetic wave absorbing unit 52 be disposed to be in close contact with an inner surface of the housing 1.

The electromagnetic wave absorbing unit 53 serving as a dissipating unit and an outer portion is disposed to be exposed to the outside of the housing 1 in such a manner that the electromagnetic wave absorbing unit 53 and the electromagnetic wave absorbing unit 52 sandwich a certain surface of the housing 1. For example, the electromagnetic wave absorbing unit 53 is disposed in such a manner that the electromagnetic wave absorbing unit 53 at least partially overlaps the electromagnetic wave absorbing unit 52 when seen in a direction (e.g. the Y direction illustrated in FIG. 7) orthogonal to a surface of the housing 1 where the electromagnetic wave absorbing unit 52 is disposed. In addition, for example, the electromagnetic wave absorbing unit 53 is disposed to be in contact with or close to an outer surface of the housing 1. Note that it is desirable that the electromagnetic wave absorbing unit 53 be disposed to be in close contact with an outer surface of the housing 1. In addition, the electromagnetic wave absorbing units 52 and 53 are not limited to being disposed to be in direct contact with an inner surface and an outer surface of the housing 1, but, for example, may be disposed to be in indirect contact, with a heat conductive sheet, a heat conductive grease, an adhesive, or the like being interposed therebetween.

As illustrated in FIG. 8, the electromagnetic wave absorbing unit 52 has: a container 52a forming a space therein; and a liquid 51b sealed inside the container 52a. The electromagnetic wave absorbing unit 53 has: a container 53a forming a space therein; and the liquid 51b sealed inside the container 53a. The space inside the container 52a and the space inside the container 53a are connected, and the container 52a and the container 53a form a closed space. Because of this, the liquid 51b sealed inside the container 52a and the liquid 51b sealed inside the container 52a can move to each other between the inside of the container 52a and the inside of the container 53a.

For example, the closed space formed by the container 52a and the container 53a has a tubular space formed to make multiple turns, and is configured in such a manner that the liquid 51b can move easily between the inside of the container 52a and the inside of the container 53a through convection. By being configured in this manner, in the electromagnetic wave absorbing units 52 and 53, the liquid 51b in the container 52a is heated by incident electromagnetic waves, and the liquid 51b in the container 53a is cooled outside the housing 1. Thereby, the convection of the liquid 51b is generated, and it becomes possible to dissipate the heat of the liquid 51b to the outside of the housing 1 by heat exchange via the liquid 51b. Note that the electromagnetic wave heating apparatus 600 may include a fan that is disposed outside the housing 1, and is for dissipating the heat of the liquid 51b to external air. In addition, the electromagnetic wave heating apparatus may include a plurality of electromagnetic wave absorbing units 52 and 53.

Note that, in the present disclosure, any combination of embodiments, modification of any constituent element in each embodiment, or omission of any constituent element in each embodiment is possible.

### INDUSTRIAL APPLICABILITY

For example, the electromagnetic wave heating apparatuses according to the present disclosure can be used as electromagnetic wave heating apparatuses having a function to separately heat a heating target object and a non-heating target object in the electromagnetic wave heating apparatuses.

### REFERENCE SIGNS LIST

1: Housing; 2: Phase control unit; 3: Antenna; 5: Electromagnetic wave absorbing unit; 6: Heating target object; 7: Non-heating target object; 8: Electromagnetic field control plane; 9: Heat dissipating unit; 10: Electromagnetic wave generating unit; 51: Electromagnetic wave absorbing unit; 51a: Container; 51b: Liquid; 52: Electromagnetic wave absorbing unit; 52a: Container; 53: Electromagnetic wave absorbing unit; 53a: Container; 100: Electromagnetic wave heating apparatus; 200: Electromagnetic wave heating apparatus; 300: Electromagnetic wave heating apparatus; 400: Electromagnetic wave heating apparatus; 500: Electromagnetic wave heating apparatus; 600: Electromagnetic wave heating apparatus; S1: Space

1. An electromagnetic wave heating apparatus comprising:
an electrically conductive housing;
an electromagnetic wave generator to generate electromagnetic waves which are linearly polarized waves;
a plurality of radiators to radiate, to an inside of the housing, the electromagnetic waves generated by the electromagnetic wave generator;
a directivity controller to control directivity of the electromagnetic waves from the plurality of radiators; and
an electromagnetic wave absorber that is disposed inside the housing in such a manner that the electromagnetic wave absorber at least partially aligns with a vibration plane of the electromagnetic waves, and to absorb electromagnetic waves inside the housing.

2. The electromagnetic wave heating apparatus according to claim 1, wherein the electromagnetic wave absorber is disposed to be in contact with or close to an inner surface of the housing.

3. The electromagnetic wave heating apparatus according to claim 1, comprising a dissipator that is disposed to be exposed to an outside of the housing, and to dissipate heat of the electromagnetic wave absorber to the outside of the housing.

4. The electromagnetic wave heating apparatus according to claim 1, wherein the electromagnetic wave absorber has: a liquid to absorb electromagnetic waves; and a container that seals in the liquid.

5. The electromagnetic wave heating apparatus according to claim 4, wherein the electromagnetic wave absorber dissipates, to an outside of the housing, heat of the electromagnetic wave absorber by heat exchange through the liquid.

6. The electromagnetic wave heating apparatus according to claim 5, wherein the electromagnetic wave absorber has: an inner portion disposed inside the housing; and an outer portion disposed to be exposed to the outside of the housing, and dissipates, to the outside of the housing, the heat of the electromagnetic wave absorber by the liquid convecting to move between the inner portion and the outer portion.

7. The electromagnetic wave heating apparatus according to claim 1, wherein
the electromagnetic wave absorber is a first electromagnetic wave absorber, and
the electromagnetic wave heating apparatus comprises a second electromagnetic wave absorber that is disposed inside the housing to face the first electromagnetic wave absorber with a distance, and to absorb electromagnetic waves inside the housing.

8. The electromagnetic wave heating apparatus according to claim 1, wherein the electromagnetic wave absorber is disposed to cover an entire inner surface of the housing.
